(19) United States
(12) Patent Application Publication
(10) Pub. No.: US 2024/0200206 A1
(43) Pub. Date: Jun. 20, 2024

(54) METHOD FOR PRODUCING HIGH PURITY LITHIUM HYDROXIDE MONOHYDRATE

(71) Applicant: ECOSTAR-NAUTECH CO., LTD, Novosibirsk (RU)

(72) Inventors: Aleksandr Dmitriyevich RIABTSEV, Novosibirsk (RU); Nikolay Mikhaylovich NEMKOV, Novosibirsk (RU); Valeriy Ivanovich TITARENKO, Novosibirsk (RU); Andrey Aleksandrovich KURAKOV, Novosibirsk (RU); Aleksandr Viktorovich LETUEV, Yurga (RU)

(73) Assignee: ECOSTAR-NAUTECH CO., LTD, Novosibirsk (RU)

(21) Appl. No.: 18/553,580

(22) PCT Filed: Mar. 30, 2022
(86) PCT No.: PCT/RU2022/050104

§ 371 Date: Oct. 2, 2023

(30) Foreign Application Priority Data
Mar. 31, 2021 (RU) 2021108817

(51) Int. Cl. C25B 1/34; C25B 9/23; C25B 11/046; C25B 11/063; C25B 11/081; C25B 13/08; C25B 15/08

(52) U.S. Cl. CPC C25B 1/34; C25B 9/23; C25B 11/046; C25B 11/063; C25B 11/081; C25B 13/08; C25B 15/083; C25B 15/085; C25B 15/087

(57) ABSTRACT

A method for producing high purity lithium hydroxide monohydrate from materials containing a lithium salt selected from Li2SO4, LiCl, Li2CO3 or mixtures thereof is provided. The method includes membrane electrolysis of an aqueous solution of the indicated lithium salt using a cation exchange membrane and a nickel-plated stainless steel cathode. The catholyte is withdrawn from the circulating stream and evaporated to give crystals of lithium hydroxide monohydrate, which are separated from the mother liquor, washed with water and dried to give the final high purity lithium hydroxide monohydrate. Part of the spent washing solution is fed into the catholyte evaporation process. Part of the mother liquor formed after the separation of crystals of lithium hydroxide monohydrate is returned to the catholyte evaporation process. The reverse flow of the anolyte is replenished with a concentrated lithium salt solution prepared from the original lithium salt.

### FIELD OF THE INVENTION

The invention belongs to the field of chemical technology for inorganic substances, and in particular to the methods for producing high purity lithium hydroxide monohydrate from lithium salts containing materials.

### BACKGROUND

It is known to produce a lithium hydroxide solution from solid carbonate-containing lithium waste by contacting the same with water, settling the resulting pulp, decanting the clarified liquid phase, followed by its filtration and recirculation of the resulting lithium-containing solution through the central chamber of the electrodialysis unit to obtain a lithium hydroxide solution in the cathode chamber, a mixed acid solution in the anode chamber, and a desalted liquid in the central chamber which is returned to the process of leaching lithium from solid carbonate-containing lithium waste [1].

The disadvantage of this method is the production of a low concentrated LiOH solution (at most 25 kg/m³) and low production efficiency of the process due to operation at a current density of at most 2 A/dm² (0.2 kA/m²), high electrical resistance of the recycled Li₂CO₃ solution due to the low Li₂CO₃ concentration (at most 10 kg/m³) and therefore high specific energy consumption per unit of product produced.

Another known method for producing lithium hydroxide solution from lithium compounds containing materials, in particular from waste lithium-ion batteries [2], comprises extracting lithium from the waste in the form of highly soluble lithium sulfate, membrane electrolysis of the lithium sulfate solution using a Nafion 350 cation-exchange membrane separating the cathode and anode compartments. The electrolysis is carried out at a direct current density of 20 A/dm² and a voltage of 5.3 V with constant withdrawal of the LiOH solution (catholyte) from the cathode compartment and of the Li₂SO₄-depleted anolyte comprising sulfuric acid formed at the anode from the anode compartment. The withdrawn anolyte stream is directed to lithium leaching process to neutralize sulfuric acid while at the same time strengthen the stream with lithium sulfate. The anolyte strengthened with Li₂SO₄ is returned to the electrolysis process.

This anolyte is disadvantageous in that it is limited to the production of the LiOH solution contaminated with impurities. It is not possible to produce high purity product in the form of LiOH·H₂O using this method.

It is known to produce high purity lithium hydroxide by membrane electrolysis of an aqueous solution containing lithium chloride and lithium carbonate recovered from natural brine in the presence of a reducing agent [3]. The withdrawn catholyte is evaporated to crystallize LiOH·H₂O. Following separation from the mother liquor, LiOH·H₂O is washed with demineralized water, dried, resulting in high purity LiOH·H₂O. Herewith cathodic hydrogen is used to produce a heat carrier for generating a heating steam utilized in the catholyte evaporation process, and anodic chlorine is used for oxidizing bromide ions to elemental bromine by directly contacting chlorine with the natural brine rich in bromide ions.

The disadvantages of this method include the use as a feed for electrochemical transformation of a low concentration LiCl solution that is first recovered from lithium-bearing natural brine by means of a LiCl-selective sorbent, as well as the need to use a reducing agent to eliminate the risk of formation of oxychloride species in the anode compartment during electrolysis of a low concentration LiCl solution.

A method for producing high purity lithium monohydrate from lithium carbonate containing materials [4] overcomes most of the disadvantages of the above methods. The method is based on the reproduction of an aqueous solution of highly soluble lithium sulfate fed to replenish the anolyte solution undergoing depletion in Li₂SO₄ and enrichment in H₂SO₄ which circulates in the anolyte circuit of the electrolysis unit. To this end a part of the lithium-depleted anolyte is constantly withdrawn from the anolyte circuit and brought into contact with an equivalent amount of lithium carbonate to convert the anodic sulfuric acid into lithium sulfate. This method also provides for the chemical purification of the reproduced Li₂SO₄ solution from Ca, Mg impurities and heavy metals via carbonate-alkaline method using a solution of LiOH and CO₂ released upon neutralization of carbonates in the anolyte.

The method has a disadvantage of using cation-exchange membranes MK-40 of low mechanical and chemical stability in the membrane electrolysis process. Furthermore, the disadvantages of the method include pollution of water with liquid waste, contamination of lithium carbonate solution with sodium and potassium carbonates, as well as unsatisfactory chemical purification of the Li₂SO₄ solution fed to the anolyte circuit for replenishment, meaning that the membranes which become contaminated with calcium and magnesium cations shall be regularly checked for the need of acid recovery.

A method for producing lithium monohydrate from brines and an apparatus for the implementation thereof [5] overcomes the disadvantages of the above method. LiOH solution fed for evaporation, crystallization, washing and drying of LiOH·H₂O is obtained from a concentrated LiCl solution subjected to chemical purification via carbonate-alkaline method followed by ion exchange purification on the Lewatit-208-TP ion exchanger in Li-form. The method also involves employing the spent catholyte stream withdrawn from the evaporation process in the form of a LiOH solution containing NaOH and KOH as a reagent for obtaining a pregnant LiCl solution, whereby sodium and potassium are removed from the process in the form of NaCl and KCl crystals. By its technical essence and the parameters achieved this method for producing lithium hydroxide monohydrate from a lithium salt containing material is the closest to the claimed method and thus was chosen as the closest prior art.

The disadvantages of the method are as follows:
1) The range of raw materials which may be used for producing LiOH·H₂O is limited to aqueous solutions of lithium chloride produced from lithium-bearing natural brines;
2) Sodium and potassium impurities accumulated in the catholyte can only be removed in the form of NaCl and KCl, while the production process of LiOH·H₂O is limited by the preparation of a pregnant lithium concentrate (a lithium concentrate suitable for the production of LiCl·H2O and LiCl) by concentrating and removing impurities from low concentrated LiCl raw materials in the form of primary lithium concentrates produced from lithium-bearing natural brines using LiCl-selective sorbents;
3) Limited range of coproducts produced upon utilization of anodic chlorine;
4) Lack of solutions for the utilization of cathodic hydrogen.

The above drawbacks can be overcome through the implementation of the following technical solutions which constitute the basis of the claimed method:
obtaining LiOH solution by membrane electrolysis of an aqueous solution of Li₂SO₄, an aqueous solution of LiCl or a mixed solution of Li₂SO₄ and LiCl, produced from the materials containing a lithium salt in the form of Li₂SO₄ or LiCl or Li₂CO₃, or various mixtures of these salts;
recycling the stream enriched with sodium and potassium withdrawn from the catholyte evaporation process (spent cation exchanger) into solid phase lithium carbonate and solid phase sodium and potassium bicarbonate;
using nickel-plated stainless steel as the cathode, thereby eliminating both hydrogen absorption (hydrogenation) at the cathode and the risk of corrosion;
using the spent washing solution which remains after washing of the LiOH·H₂O crystals as the alkaline reagent in the processes of pretreating the aqueous lithium salts prior to membrane electrolysis;
using new solutions for the utilization of cathodic and anodic coproducts of the membrane electrolysis of aqueous solutions of lithium salts.

The implementation of the provided technical solutions makes it possible to expand the range of raw materials suitable for the production of lithium hydroxide monohydrate, increase the reliability of the membrane electrolysis process, expand the range of the coproducts produced, eliminate the formation of liquid and gaseous waste and, consequently, improve the environmental performance of the production process.

### SUMMARY OF THE INVENTION

The achievement of the technical effect is provided by using lithium sulfate or lithium chloride, or lithium carbonate, or various mixtures of these salts as the lithium salt containing material; using cathodes made of nickel-plated stainless steel in the processes of membrane electrolysis of the aqueous solutions of lithium salts; and using the membranes of Nafion-348, CTIEM-3, MF-4SK-100 types or membranes equivalent thereto as the cation-exchange membranes.

The achievement of the technical effect is provided by that the spent washing solution fed to the catholyte evaporation process is partially used as an alkaline reagent in the process of pretreating the lithium salt solution brought to a predetermined concentration prior to electrolysis, first at the step of chemical purification of this salt solution from impurities and then as a regenerating solution for converting the ion exchanger from H-form into Li-form at the step of ion exchange purification.

The achievement of the technical effect is provided by that the recycling of the spent catholyte stream, which represents a lithium hydroxide solution with an admixture of sodium hydroxide and potassium hydroxide, is carried out by mixing it with the stream of an aqueous solution containing sodium, potassium and lithium bicarbonates; the resulting pulp, which represents a mixture of a solid phase of lithium carbonate and a solution containing Na₂CO₃, K₂CO₃ and Li₂CO₃, is concentrated by removing a predetermined amount of water; the solid phase of lithium carbonate is separated from the liquid phase, the liquid phase is carbonized by contacting it with carbon dioxide to convert the carbonate solution into a bicarbonate suspension, which represents a mixture of solid phases of sodium bicarbonate and potassium bicarbonate in a solution of sodium, potassium and lithium bicarbonates; the resulting suspension is filtered to separate the solid phase of sodium and potassium bicarbonates from the solution containing sodium, potassium and lithium bicarbonates which is directed to mixing with the spent catholyte stream withdrawn from the evaporation process containing lithium, sodium and potassium hydroxides.

The achievement of the technical effect is provided by that when lithium sulfate is used as the lithium salt containing material, titanium coated with a noble metal: platinum, ruthenium, iridium, tantalum, is used as the anodes in the membrane electrolysis process, and an anolyte stream of a predetermined volume is constantly withdrawn at a predetermined rate from the circulating anolyte stream undergoing depletion in Li₂SO₄ and enrichment in H₂SO₄; the withdrawn anolyte stream is brought into contact with CaO, or with Ca(OH)₂, or with CaCO₃ until H₂SO₄ is completely neutralized; the resulting solid phase of CaSO₄·2H₂O is separated from the Li₂SO₄ solution, the Li₂SO₄ solution is brought into contact with a predetermined mass quantity of the initial Li₂SO₄ salt to dissolve it and to obtain a Li₂SO₄ solution of a predetermined concentration; the resulting solution is added with a predetermined volume of a washing solution followed by carbonizing the solution with carbon dioxide coming from the process of neutralization of the withdrawn anolyte stream, until the calcium and magnesium contained in the solution are converted into insoluble compounds CaCO₃ and Mg(OH)₂·3MgCO₃·3H₂O; the resulting suspension is filtered to separate the precipitate from the Li₂SO₄ solution, the chemically purified Li₂SO₄ solution is directed to ion exchange purification by passing it through a layer of Lewatit-208-TP ion exchanger in Li-form or an equivalent ion exchanger in Li-form; the Li₂SO₄ solution that has undergone ion exchange purification is used as a replenishing solution for the circulating anolyte stream in the membrane electrolysis process; the spent ion exchanger is regenerated in two steps: the first step consists in the treatment with 2.0N sulfuric acid solution, the second step consists in the treatment with 2N LiOH solution prepared from the spent washing solution, the spent regenerates are mixed with the spent anolyte stream before its chemical purification; cathodic hydrogen, which is a coproduct of electrolysis, is ejected with a natural gas stream from the cathode gas separator of the electrolysis unit, the resulting gaseous mixture is directed to the steam generator as the fuel for the generation of a heating steam used as a heat carrier in the processes of evaporation of solutions and, in particular, of the catholyte.

The achievement of the technical effect is provided by that when lithium sulfate is used as the lithium salt containing material, a predetermined volume of the anolyte constantly withdrawn at a predetermined volumetric rate from the circulating anolyte stream undergoing depletion in Li₂SO₄ and enrichment in H₂SO₄ is brought into contact with an air-ammonia mixture to neutralize H₂SO₄, to obtain a mixed solution of Li₂SO₄ and (NH₄)₂SO₄ which is evaporated to salt out (NH₄)₂SO₄; the evaporated solution with the remaining (NH₄)₂SO₄ is mixed with a predetermined volume of the spent washing solution while bringing into contact with the air stream coming from the process of contacting the spent alkaline anolyte stream with the ammonia-air mixture to remove the remaining ammonia from the Li₂SO₄ solution; the gaseous ammonia containing air stream is enriched with ammonia from an ammonia source and directed to the process of neutralizing the spent anolyte stream; the ammonia-free Li₂SO₄ solution after a predetermined strengthening with Li₂SO₄ by dissolving therein a predetermined mass quantity of the initial lithium sulfate salt and chemical and ion exchange purification from impurities, is used as a replenishing solution for the circulating anolyte stream in the membrane electrolysis process.

The achievement of the technical effect is provided by that when lithium chloride or lithium chloride monohydrate is used as the lithium salt containing material, titanium anodes coated with a ruthenium oxide are used in the membrane electrolysis process, and a predetermined volume of anolyte is constantly withdrawn at a predetermined volumetric rate from the circulating anolyte stream undergoing depletion in LiCl; the withdrawn anolyte stream is brought into contact with the initial salt containing lithium chloride to bring the LiCl concentration in the withdrawn anolyte stream to a predetermined value; the withdrawn LiCl-enriched anolyte stream in addition to chemical purification from metal cation impurities is also purified from sulfate ions by adding a predetermined amount of barium chloride to convert sulfate ions into an insoluble BaSO₄ precipitate; the liquid phase is separated from the precipitates and, following ion exchange purification, used as a replenishing solution for the circulating anolyte stream in the membrane electrolysis process; the cathodic hydrogen and anodic chlorine withdrawn from the gas separators are mixed and subjected to flame combustion; the resulting hydrogen chloride is absorbed by demineralized water to produce a concentrated 36% hydrochloric acid.

The achievement of the technical effect is provided by that when lithium chloride or lithium chloride monohydrate is used as the lithium salt containing material, the anodic chlorine withdrawn from the gas separator is absorbed by aqueous ammonia to produce, at a molar ratio of NH₃:Cl₂=8:3, a NH₄Cl solution, and at a molar ratio of NH₃:Cl₂=2:3, a 6N HCl solution; the resulting NH₄Cl solution is evaporated, NH₄Cl is crystallized, the crystals are dried, the withdrawn hydrogen in this case is utilized as a heat carrier for the generation of the heating steam.

The achievement of the technical effect is provided by that when lithium chloride or lithium chloride monohydrate is used as the lithium salt containing material, the anodic chlorine withdrawn from the gas separator is completely absorbed by a NaOH solution to produce a disinfecting solution of sodium hypochlorite, or 0.5 of the withdrawn volumetric flow of chlorine is absorbed by a NaOH solution to produce a solution saturated with sodium hypochlorite, and the other 0.5 of the withdrawn volumetric flow of anodic chlorine is absorbed by a Ca(OH)₂ suspension to produce a solution saturated with calcium hypochlorite; the produced solutions are mixed to salt out the neutral calcium hypochlorite which is separated from the mother liquor and dried, calcium is precipitated out of the resulting mother liquor, first in the form of Ca(OH)₂ by adding a predetermined amount of NaOH, and then in the form of CaCO₃ by adding a predetermined amount of Na₂CO₃; the precipitate containing Ca(OH)₂ with an admixture of CaCO₃ is separated from the solution containing active chlorine in the form of hypochlorite ions; the solution is divided into two equal portions, one portion is mixed with a predetermined amount of NaOH and directed to chlorination to obtain a sodium hypochlorite solution, another portion is mixed with a predetermined amount of Ca(OH)₂ and is also directed to chlorination process to obtain a calcium hypochlorite solution; the cathodic hydrogen is utilized as a heat carrier for the generation of the heating steam.

The achievement of the technical effect is provided by that when lithium carbonate is used as the lithium salt containing material, lithium carbonate salt is used to reproduce highly soluble salts of lithium chloride or lithium sulfate circulating in the form of aqueous solutions in the anolyte circuit of the electrolysis unit and undergoing depletion in LiCl or Li₂SO₄ during membrane electrolysis, wherein if an aqueous solution of lithium chloride is used as the anolyte, titanium anodes coated with ruthenium oxide are used in membrane electrolysis process, wherein according to the first option, the withdrawn cathodic hydrogen and anodic chlorine are combusted after mixing to produce high-temperature hydrogen chloride vapor, the hydrogen chloride vapor is cooled and absorbed by demineralized water in a stepwise countercurrent mode to obtain a stream of concentrated (36%) hydrochloric acid from the first absorption step along the path of the HCl vapor; the stream of the resulting concentrated hydrochloric acid is mixed with a stream of anolyte purified from sulfate ions using BaCl₂ as the reagent, withdrawn for purification from sulfate ions from the circulating anolyte stream in the membrane electrolysis process; the mixed stream of the concentrated hydrochloric acid and the anolyte purified from sulfate ions is brought into contact with the predetermined amounts of the initial lithium carbonate and demineralized water to obtain a stream of LiCl solution of a predetermined concentration which, after being purified from calcium and magnesium impurities, is used as a replenishing solution for the circulating anolyte stream in the membrane electrolysis process; according to the second option, the withdrawn anodic chlorine is absorbed by demineralized water in the presence of ammonia at a mole ratio of NH₃:Cl₂=2:3 to obtain a 6N hydrochloric acid solution, which is mixed with a stream of anolyte purified from sulfate ions using BaCl₂ as the reagent, withdrawn for purification from sulfate ions from the circulating anolyte stream in the membrane electrolysis process; the mixed stream of the hydrochloric acid solution and the anolyte purified from sulfate ions is brought into contact with a predetermined amount of the initial lithium carbonate to obtain a LiCl salt solution stream, which, after being purified from calcium and magnesium impurities, is used as a replenishing solution for the circulating anolyte stream in the membrane electrolysis process, and the cathodic hydrogen is used as a fuel for the generation of the heating steam; according to the third option, the anodic chlorine is absorbed by an aqueous pulp of lithium carbonate with a predetermined content of Li₂CO₃ and in the presence of a predetermined amount of a reducing agent for elemental chlorine, the material composition of which prevents the absorber from contamination with foreign cations and anions, such as ammonia, hydrazine, hydroxylamine, carbamide, formic acid, or reducing agents equivalent thereto, to obtain as the absorption product a lithium chloride solution with a predetermined LiCl concentration, which is used as a replenishing solution for the circulating anolyte stream in the membrane electrolysis process, whereby the aqueous pulp for the absorption of the anodic chlorine is prepared from demineralized water, lithium carbonate obtained from spent catholyte, lithium carbonate in the form of the initial Li₂CO₃ salt, a reducing agent and the anolyte stream purified from sulfate ions using BaCl₂ as the reagent, which in turn is withdrawn from the circulating anolyte stream with a predetermined volumetric flow rate in the membrane electrolysis process, and the cathodic hydrogen is used as a fuel for the generation of the heating steam.

In case of using an aqueous solution of lithium sulfate as the anolyte, titanium anodes coated with noble metals: platinum, ruthenium, iridium, tantalum, are used in the membrane electrolysis process, and the anolyte stream of a predetermined volume depleted in lithium sulfate and enriched in sulfuric acid, withdrawn at a predetermined rate from the anolyte circulation circuit, is brought into contact with a predetermined amount of the initial lithium carbonate to obtain a lithium sulfate solution of a predetermined concentration, which, after purification from impurities, is used as a replenishing solution for the anolyte circulation circuit.

The achievement of the technical effect is provided by that when a mixture of lithium salts lithium sulfate and lithium carbonate is used as the lithium salt containing material, titanium coated with noble metals: platinum, ruthenium, iridium, tantalum, is used as the anodes in the membrane electrolysis process, and the anolyte stream of a predetermined volume depleted in lithium sulfate and enriched in sulfuric acid, withdrawn at a predetermined rate from the anolyte circulation circuit, is brought into contact with a predetermined amount of the initial mixture of Li₂SO₄ and Li₂CO₃ salts to obtain a lithium sulfate solution of a predetermined concentration with a residual content of H₂SO₄; the resulting Li₂SO₄ solution is freed from the residual sulfuric acid and after purification from impurities is used as a replenisher for the circulating anolyte stream in the membrane electrolysis process.

The achievement of the technical effect is provided by that when a mixture of lithium chloride and lithium carbonate salts is used as the lithium salt containing material, titanium coated with ruthenium oxide is used as the anodes in the membrane electrolysis process, and the initial mixture of lithium chloride and carbonate salts is brought into contact with a predetermined volume of hydrochloric acid of a predetermined concentration and a predetermined volumetric flow of the anolyte withdrawn from the circulating anolyte stream, depleted in LiCl during membrane electrolysis, to produce a lithium chloride solution, the resulting lithium chloride solution after purification from impurities is used as a replenishing solution for the circulating anolyte stream in the membrane electrolysis process.

The achievement of the technical effect is provided by that when a mixture of lithium salts lithium sulfate and lithium chloride is used as the lithium salt containing material, titanium coated with noble metals: platinum, ruthenium, iridium, tantalum, is used as the anodes in the membrane electrolysis process, and an anolyte stream of a predetermined volume is withdrawn at a predetermined rate from the circulating anolyte stream undergoing depletion in lithium sulfate and chloride and enrichment in H₂SO₄, which is either brought into contact with a predetermined amount of ammonia contained in the ammonia-air mixture, followed by concentration of the mixed sulfite solution of Li₂SO₄ and (NH₄)₂SO₄ and salting out the (NH₄)₂SO₄ salt until a Li₂SO₄ solution is obtained, or brought into contact with a predetermined amount of either Ca(OH)₂ or CaCO₃ until the H₂SO₄ is completely neutralized and a Li₂SO₄ solution is obtained, which is separated from the CaSO₄·2H₂O precipitate; the Li₂SO₄ solution obtained either way is brought into contact with a predetermined amount of the initial mixture of Li₂SO₄ and LiCl salts to dissolve it and to obtain a mixed solution of Li₂SO₄ and LiCl with a predetermined concentration of lithium, which after purification from impurities is used as a replenishing solution for the circulating anolyte stream in the membrane electrolysis process; the anodic chlorine withdrawn from the gas separator is recycled into a 36% hydrochloric acid, or into a NH₄Cl salt, or into a sodium hypochlorite solution, or into a neutral calcium hypochlorite.

The achievement of the technical effect is provided by that when a mixture of lithium sulfate, lithium chloride and lithium carbonate salts is used as the lithium salt containing material, titanium coated with noble metals is used as the anodes in the membrane electrolysis process, and a predetermined volume of the anolyte is constantly withdrawn at a predetermined volumetric rate from the circulating anolyte stream undergoing depletion in Li₂SO₄ and LiCl and enrichment in H₂SO₄, which is first brought into contact with a predetermined amount of the initial mixture of Li₂SO₄, LiCl and Li₂CO₃ salts to produce a mixed solution of Li₂SO₄, LiCl, H₂SO₄ with a predetermined concentration of lithium, the resulting mixed solution is converted into a mixed solution of Li₂SO₄ and LiCl, which is used as a replenishing solution for the anolyte circulating stream in the membrane electrolysis process.

### BRIEF DESCRIPTION OF THE DRAWINGS

FIG. 1. A flow diagram illustrating production of LiOH·H₂O from a material containing a lithium salt in the form of the Li₂SO₄ salt

FIG. 2. A flow diagram illustrating production of LiOH·H₂O from a material containing a lithium salt in the form of the LiCl salt

FIG. 3. A flow diagram illustrating production of LiOH·H₂O from a material containing a lithium salt in the form of the Li₂CO₃ salt

FIG. 4. A flow diagram illustrating production of LiOH·H₂O from a material containing a lithium salt in the form of the mixture of Li₂SO₄ and Li₂CO₃ salts

FIG. 5. A flow diagram illustrating production of LiOH·H₂O from a material containing a lithium salt in the form of the mixture of LiCl and Li₂CO₃ salts

FIG. 6. A flow diagram illustrating production of LiOH·H₂O from a material containing a lithium salt in the form of the mixture of Li₂SO₄ and LiCl salts

FIG. 7. A flow diagram illustrating production of LiOH·H₂O from a material containing a lithium salt in the form of the mixture of Li₂SO₄, LiCl and Li₂CO₃ salts

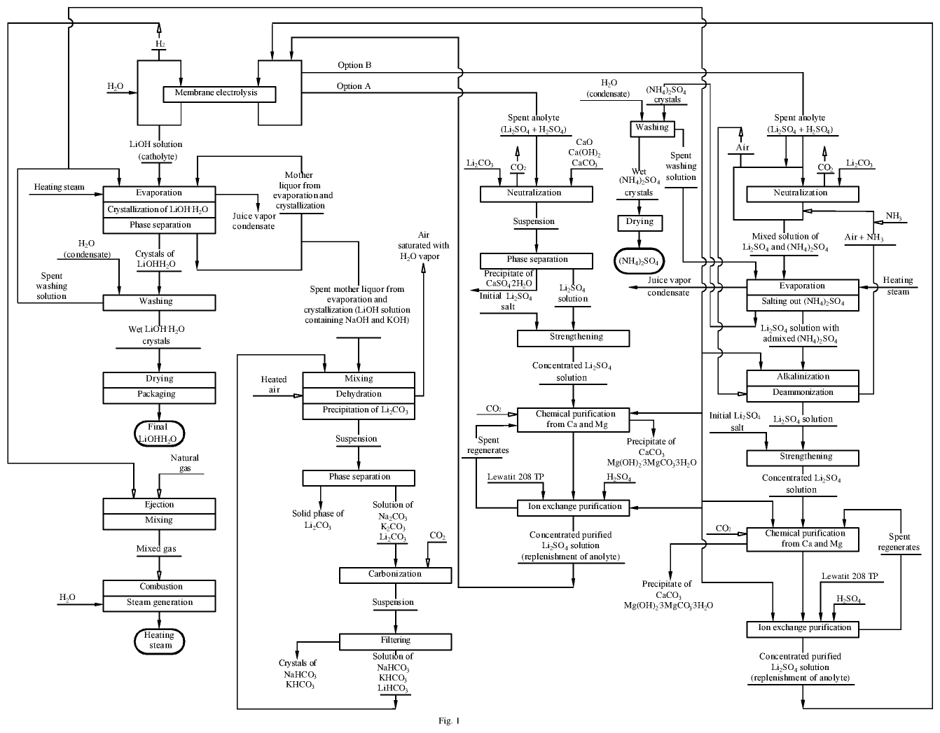

The implementation of the provided invention is carried out in accordance with the flow diagrams of the production of lithium hydroxide monohydrate from the materials containing lithium salts or mixtures thereof, as shown in FIG. 1-7, and is supported by the provided examples.

A process flow diagram of the production of LiOH·H₂O from a material containing a lithium salt in the form of the Li₂SO₄ salt is shown on FIG. 1. The technology is based on the membrane electrolysis process which enables the electrochemical conversion of a Li₂SO₄ solution into a LiOH solution. Herewith the process of electrochemical conversion occurs upon applying a direct current and employs cation-exchange membranes stable in alkaline and acid solutions separating the cathode and anode compartments of the electrolysis units through which the LiOH solution (catholyte) and Li₂SO₄ solution (anolyte), respectively, constantly circulate. During the circulation of solutions they undergo electrode processes upon contact with the electrodes. Herewith electrochemical oxidation of water takes place at the anodes resulting in the oxygen gas and H⁺ ions according to the reaction:

H₂O−2e⁻→2H⁺+½O₂↑ (1)

Accordingly, electrochemical decomposition of water occurs at the cathodes resulting in hydrogen gas and OH⁻ ions according to the reaction:

2H₂O+2e⁻→2OH+H₂↑ (2)

In a general form, the process of electrochemical conversion of Li₂SO₄ to LiOH can be described by the following reaction:

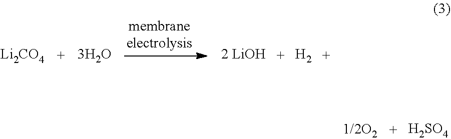

The cation-exchange membrane permits unhindered transfer of cations from the anode compartment to the cathode compartment. At that the transfer of SO₄²⁻ ions from the anode compartment to the cathode compartment and of OH⁻ ions from the cathode compartment is prevented due to the specific features of cation-exchange membranes. Since the anolyte is being constantly depleted in Li₂SO₄ and enriched in H₂SO₄, and the catholyte is being constantly enriched in LiOH, the circulating anolyte is constantly replenished with fresh Li₂SO₄ solution. The optimal range of the current density is 2-4 kA/m² while maintaining the concentration of lithium in the circulating anolyte in the range of 20-25 kg/m³. The optimal concentration of lithium hydroxide in the circulating catholyte is in the range of 50-80 kg/m³. The membranes of Nafion-434, Nafion-438, Nafion-324, CTIEM-3, MF-4SK-100 types and other equivalent membranes resistant to alkalis and acids can be used as cation-exchange membranes. For the cathodes, it is advisable to use perforated plates made of nickel-plated stainless steel, which eliminates both the risk of hydrogenation of the structural material of cathodes with cathodic hydrogen and the risk of their corrosion during emergency stops and interruption of the current load. The most durable anodes in the electrolysis of sulfate solutions are the anodes made of platinized titanium; in addition, titanium with an iridium-ruthenium oxide coating can be used as the anodes. A catholyte stream of a predetermined capacity is constantly withdrawn from the circulating catholyte with the Li₂SO₄ solution produced by membrane electrolysis and sent to the process of evaporation and crystallization of LiOH·H₂O. LiOH·H₂O crystals are usually separated from the mother liquor upon evaporation by centrifugation, the separated crystals are washed from the remainder of the mother liquor with demineralized water and dried to give the LiOH·H₂O product which meets the requirements of the LGO-1 GOST 8595-83 grade. The mother liquor formed after evaporation and separation of the crystals is returned to evaporation. Since sodium and potassium are contained as impurities in the lithium sulfate salt fed to electrolysis together with the lithium pass into the catholyte, they gradually accumulate in the evaporated catholyte to concentrations at a level which does not allow producing a product that meets the requirements of the LGO-1 grade. For this reason a predetermined volume is constantly withdrawn from the alkaline solution returned to the catholyte evaporation process formed after the separation of the LiOH·H₂O crystals, and is directed to recycling, which ensures returning of lithium to production process. Recycling of the spent catholyte consists in separating lithium from alkali metal impurities based on a significant difference in the solubility of the compounds Li₂CO₃, LiHCO₃, Na₂CO₃, NaHCO₃, K₂CO₃, KHCO₃. Herewith lithium carbonate is the least soluble compound, and K₂CO₃ is the most soluble compound among the given list. In turn, sodium and potassium bicarbonates are much less soluble than their carbonates, and the solubility of lithium bicarbonate, on the contrary, is much higher than the solubility of lithium carbonate. At the initial step of recycling a mixed bicarbonate solution saturated with KHCO₃, NaHCO₃ and LiHCO₃ is prepared, and its stream is mixed with the stream of the spent catholyte being recycled. Upon mixing of the streams the following reactions occur, resulting in the precipitation of poorly soluble lithium carbonate and the conversion of potassium and sodium bicarbonates into carbonates of a significantly higher solubility than the corresponding bicarbonates:

2LiOH₍ₛₒₗᵤₜᵢₒₙ₎(Na,K)+2KHCO₃₍ₛₒₗᵤₜᵢₒₙ₎→Li₂CO₃₍ₛ₎↓+K₂CO₃₍ₛₒₗᵤₜᵢₒₙ₎ (4)

2LiOH₍ₛₒₗᵤₜᵢₒₙ₎(Na,K)+2NaHCO₃₍ₛₒₗᵤₜᵢₒₙ₎→Li₂CO₃₍ₛ₎↓+Na₂CO₃₍ₛₒₗᵤₜᵢₒₙ₎ (5)

2LiOH₍ₛₒₗᵤₜᵢₒₙ₎(Na,K)+2LiHCO₃₍ₛₒₗᵤₜᵢₒₙ₎→Li₂CO₃₍ₛ₎↓+Li₂CO₃₍ₛₒₗᵤₜᵢₒₙ₎ (6)

The mixing process is combined with the process of removing excess water coming with the spent catholyte stream. The removal of water is carried out by directly contacting the resulting suspension with a predetermined stream heated to a temperature above 100° C. As a result of the contacting the heated air with the suspension water evaporates from the suspension while the air is cooled to the temperature of the wet thermometer. In turn, the removal of water from the suspension results in an increase in the degree of conversion of Li₂CO₃ into solid phase. At the same time, the liquid phase is enriched with sodium and potassium coming from the spent catholyte. The resulting solid phase of Li₂CO₃ is separated from the carbonate solution by centrifugation and directed to the process of neutralizing the spent anolyte, and the resulting carbonate solution is converted into a bicarbonate solution by treatment with carbon dioxide according to the reactions:

K₂CO₃₍ₛₒₗᵤₜᵢₒₙ₎+CO_{2(g)}+H₂O₍ₗ₎→2KHCO_{3(solution, s)} (7)

Na₂CO₃₍ₛₒₗᵤₜᵢₒₙ₎+CO_{2(g)}+H₂O₍ₗ₎→2NaHCO_{3(solution, s)} (8)

Li₂CO₍ₛₒₗᵤₜᵢₒₙ₎+CO_{2(g)}+H₂O₍ₗ₎→2LiHCO₃₍ₛₒₗᵤₜᵢₒₙ₎ (9)

Due to the oversaturation of NaHCO₃ and KHCO₃ solutions due to their enrichment with sodium and potassium coming from the spent catholyte, part of the sodium and potassium bicarbonates will remain in the solid phase, while the lithium bicarbonate formed from the dissolved Li₂CO₃ due to its higher solubility will never remain in the solid phase. The resulting solid phase of sodium and potassium bicarbonates is separated from the bicarbonate solution by filtration. The bicarbonate solution is directed to mixing with the next batch of spent catholyte.

Since during membrane electrolysis the circulating anolyte undergoes depletion in Li₂SO₄ and enrichment in H₂SO₄, a predetermined anolyte stream is constantly withdrawn from the circulating anolyte stream and is first brought into contact with lithium carbonate obtained upon recycling of the spent catholyte to neutralize a part of the sulfuric acid according to the reactions:

H₂SO₄₍ₛₒₗᵤₜᵢₒₙ₎+Li₂CO₃₍ₛ₎→Li₂SO₄₍ₛₒₗᵤₜᵢₒₙ₎+CO_{2(g)}+H₂O₍ₗ₎ (10)

During acid neutralization with lithium carbonate the spent anolyte is partially strengthened with Li₂SO₄. Afterwards there are two possible options for the preparation of the neutralized anolyte for electrolysis. According to the first option (option A), the spent anolyte solution after neutralization with lithium carbonate is brought into contact with calcium oxide, or calcium hydroxide, or calcium carbonate, or a mixture thereof, to convert sulfuric acid into the solid phase of CaSO₄·2H₂O according to the reactions:

H₂SO₄₍ₛₒₗᵤₜᵢₒₙ₎+CaO₍ₛ₎+H₂O₍ₗ₎→CaSO₄·2H₂O₍ₛ₎ (11)

H₂SO₄₍ₛₒₗᵤₜᵢₒₙ₎+Ca(OH)_{2(g)}→CaSO₄·2H₂O₍ₛ₎ (12)

H₂SO₄₍ₛₒₗᵤₜᵢₒₙ₎+CaCO₃₍ₛ₎+H₂O₍ₗ₎→CaSO₄·2H₂O₍ₛ₎+CO_{2(g)} (13)

After separation from the precipitate, the spent anolyte, which is a solution of Li₂SO₄, completely freed from sulfuric acid is brought into contact with a predetermined mass quantity of the initial Li₂SO₄ salt after the dissolution of which the solution will have a predetermined content of Li₂SO₄. Next, the resulting Li₂SO₄ solution is chemically purified from calcium and magnesium, if necessary. The process of chemical purification is necessary if the level of calcium and magnesium in the initial Li₂SO₄ salt is significant. The predetermined part of the spent washing solution (120 kg/m³ LiOH solution containing NaOH and KOH at a total level of 0.1 kg/m³) and carbon dioxide are used as the reagents. The purification process is described by the following chemical equations:

Ca₍ₛₒₗᵤₜᵢₒₙ₎+2LiOH₍ₛₒₗᵤₜᵢₒₙ₎+CO_{2(g)}→CaCO₃₍ₛ₎↓+2Li₍ₛₒₗᵤₜᵢₒₙ₎⁺+H₂O₍ₗ₎ (14)

4Mg₍ₛₒₗᵤₜᵢₒₙ₎²⁺+8LiOH₍ₛₒₗᵤₜᵢₒₙ₎+3 CO_{2(g)}→Mg(OH)₂·3MgCO₃·3 H₂O₍ₛ₎↓+8Li₍ₛₒₗᵤₜᵢₒₙ₎⁺ (15)

The chemical purification generally allows to bring the rest of the total content of calcium and magnesium in the analyzed solution to the level of 10-15 g/m³. After separation of the precipitates the Li₂SO₄ solution is directed to ion exchange purification; to this end the Lewatit 208 TP ion exchanger in Li-form or its anolyte also in Li-form are used. The ion exchange purification process is described by the following reaction equations:

Sorption step

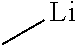

Regeneration step:

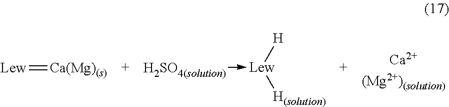

Step of converting from H-form to Li-form

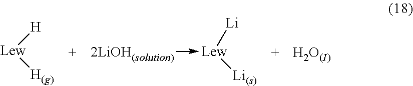

Ion exchange purification allows to bring the residual total concentration of calcium and magnesium in the Li₂SO₄ solution to a level not exceeding 0.1 g/m³, and this solution is used as the replenishing solution for the circulating anolyte stream in the membrane electrolysis process.

According to another option (option B), the withdrawn anolyte stream is first partially neutralized with lithium carbonate obtained at the stage of recycling of the spent catholyte, then with ammonia upon directly contacting the partially neutralized spent anolyte with the air-ammonia mixture, to convert the remaining sulfuric acid into ammonium sulfate according to the reaction:

2NH_{3(g)}+H₂SO₄₍ₛₒₗᵤₜᵢₒₙ₎→(NH₄)₂SO₄₍ₛₒₗᵤₜᵢₒₙ₎ (19)

The mixed solution of Li₂SO₄ and (NH₄)₂SO₄ obtained by complete neutralization of the spent anolyte is evaporated by salting out (NH₄)₂SO₄ from the mixed solution. Ammonium sulfate after washing from the mother brine and drying represents a commercial fertilizer sold on the market. The Li₂SO₄ solution obtained from the spent anolyte with a residual content of (NH₄)₂SO₄ is in turn alkalized using a part of the spent washing solution formed during the washing process of the LiOH·H₂O crystals.

After alkalinization, the solution is deammonized by aeration with a stream of atmospheric air. The deammonization process is described by the following chemical equation:

(NH₄)₂SO₄₍ₛₒₗᵤₜᵢₒₙ₎+2LiOH₍ₛₒₗᵤₜᵢₒₙ₎→2NH_{3(g)}+Li₂SO₄₍ₛₒₗᵤₜᵢₒₙ₎+2H₂O (20)

The gaseous ammonia containing air stream is enriched with a predetermined amount of ammonia and directed to neutralize the next portion of the spent and partially neutralized anolyte.

The Li₂SO₄ solution subjected to the deammonization step is sent for additional strengthening by dissolving a predetermined mass quantity of the initial Li₂SO₄ salt and, after chemical and ion exchange purification, is used as a replenishing solution for the circulating anolyte stream.

A coproduct of membrane electrolysis, cathodic hydrogen, is ejected from the cathode gas separator with a natural gas stream. The resulting gaseous mixture is utilized as a fuel for the generation of a heating steam. The heating steam is used in evaporation processes. The juice vapor condensate formed during the evaporation processes is used as the demineralized water in the processes of washing the crystals obtained by evaporation of the solutions.

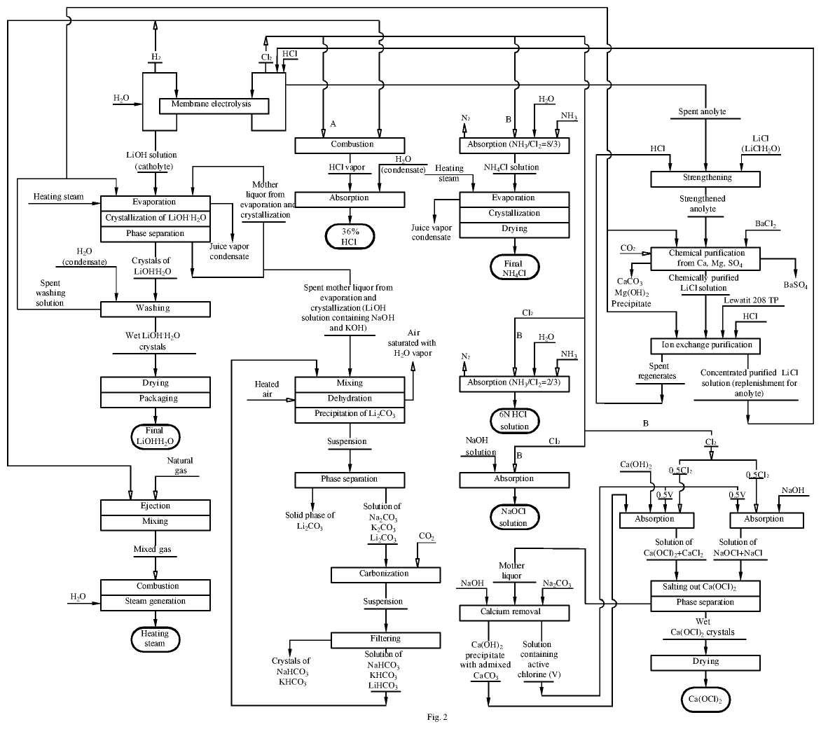

A process flow diagram of the production of LiOH·H₂O from a material containing a lithium salt in the form of the LiCl or LiOH·H₂O salt is shown on FIG. 2. In this case the technology is based on the membrane electrolysis process which enables the electrochemical conversion of a LiCl solution into a LiOH solution. Herewith the cathode process occurring under the conditions of membrane electrolysis of the LiCl solution is similar to the cathodic process occurring under the conditions of membrane electrolysis of the Li₂SO₄ solution. In turn, the anodic process under the conditions of membrane electrolysis of a LiCl solution has a significant difference since it is accompanied by electrochemical oxidation of chloride ions resulting in chlorine gas according to the reaction:

Cl⁻−e⁻→½ Cl₂ (21)

In this case no acid is formed and only depletion of the anolyte in LiCl occurs during electrolysis.

In a general form, the process of electrochemical conversion of LiCl salt solution to LiOH solution can be described by the following overall reaction:

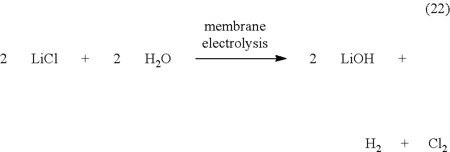

The same cathodes and cation-exchange membranes are used in the conditions of membrane electrolysis of LiCl salt solution as in the conditions of electrolysis of the Li₂SO₄ salt solution. The main parameters of the process of membrane electrolysis of soluble salts are virtually the same. However, instead of expensive anodes made of platinized titanium or titanium coated with other noble metals usually used in the electrolysis of lithium sulfate solution, titanium anodes coated with ruthenium oxide (Oxidized Ruthenium-Titanium Anodes (ORTA)) can be successfully used in the electrolysis of lithium chloride solution, provided that the chloride anolyte is acidified to pH=2. Acidification of the chloride-containing anolyte also eliminates the risk of the formation of chlorates in the circulating anolyte. The schemes of withdrawal and processing of the catholyte into final LiOH·H₂O for the electrochemical conversion of sulfate and chloride solutions of lithium are the same. Withdrawal and pretreatment for electrolysis of the spent (depleted in LiCl) anolyte are similar to the scheme and pretreatment of the sulfate anolyte, except that the pretreatment of the spent chloride anolyte does not require a neutralization process and the strengthening of the spent anolyte to a predetermined concentration of lithium is carried out by dissolving a predetermined amount of the initial LiCl salt. Since sulfate ions introduced as impurities contained in the initial lithium chloride used in the process can accumulate in the circulating anolyte stream, the chemical purification of the spent anolyte strengthened with LiCl provides for, along with purification from calcium and magnesium, purification from sulfate ions by converting them into the insoluble BaSO₄ salt using BaCl₂ as the precipitating agent. During the process of ion exchange purification of the lithium chloride solution strengthened with LiCl, the acid regeneration step is carried out with a 2N hydrochloric acid solution.

Utilization of the coproducts of membrane electrolysis, hydrogen (cathodic gas) and chlorine (anodic gas), can be dome in multiple ways. According to option A, hydrogen and chlorine withdrawn from the gas separator are mixed and subjected to high-temperature combustion to produce hydrogen chloride gas according to the reaction:

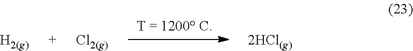

The resulting stream of high-temperature hydrogen chloride is subjected to forced cooling and directed to a stepwise countercurrent absorption using demineralized water as the initial absorbent, which can be represented by a by-product of the evaporation processes, juice vapor condensate. Option B involves the use of cathodic hydrogen as a fuel for the generation of the heating steam used in the solution evaporation processes. According to this option chlorine can be utilized as the NH₄Cl salt by evaporating the NH₄Cl solution obtained by water absorption of the gaseous mixture of NH₃ and Cl₂ at a molar ratio of NH₃:Cl₂=8:3 according to the reaction:

8 NH_{3(g)}+3 Cl_{2(g)}→6 NH₄Cl₍ₛₒₗᵤₜᵢₒₙ₎+N_{2(g)}, (24)

or as a 6N HCl solution obtained by aqueous absorption of the gaseous mixture of NH₃ and Cl₂ at a molar ratio of NH₃:Cl₂=2:3 according to the reaction:

2 NH_{3(g)}+3 Cl_{2(g)}→6 HCl₍ₛₒₗᵤₜᵢₒₙ₎+N_{2(g)}, (25)

or as a sodium hypochlorite solution (disinfecting and antiseptic solution) by absorbing chlorine with an aqueous solution of NaOH according to the reaction:

Cl_{2(g)}+2 NaOH₍ₛₒₗᵤₜᵢₒₙ₎→NaOCl₍ₛₒₗᵤₜᵢₒₙ₎+NaCl₍ₛₒₗᵤₜᵢₒₙ₎+H₂O₍ₗ₎, (26)

or as neutral calcium hypochlorite by drying this Ca(OCl)₂ salt, isolated upon an exchange reaction between sodium hypochlorite solution saturated with NaOCl obtained by absorbing half of the anodic chlorine by a concentrated NaOH solution according to the reaction:

Cl_{2(g)}+NaOH₍ₛₒₗᵤₜᵢₒₙ₎→NaOCl₍ₛₒₗᵤₜᵢₒₙ₎+α̨NaCl₍ₛ₎↓+(1−α̨)NaCl₍ₛₒₗᵤₜᵢₒₙ₎+H₂O₍ₗ₎ (27)

and the solution saturated with Ca(OCl)₂ obtained by the absorption of the half of the anodic chlorine by calcium hydroxide pulp according to the reaction:

2 Cl_{2(g)}+2Ca(OH)_{2(s, solution)}→Ca(OCl)₂₍ₛₒₗᵤₜᵢₒₙ₎+CaCl₂₍ₛₒₗᵤₜᵢₒₙ₎+2 H₂O₍ₗ₎ (28)

The main amount of calcium is precipitated from the mother liquor containing active chlorine, obtained upon conducting the exchange reaction and containing Ca²⁺, Na⁺, Cl⁻, OCl⁻ ions, by introducing a predetermined amount of NaOH into the solution, according to the reaction:

Ca²⁺₍ₛₒₗᵤₜᵢₒₙ₎+2NaOH₍ₛₒₗᵤₜᵢₒₙ₎→Ca(OH)₂₍ₛₒₗᵤₜᵢₒₙ₎↓+2Na⁺₍ₛₒₗᵤₜᵢₒₙ₎ (29)

The residual amount of calcium is removed from the solution by adding a predetermined amount of Na₂CO₃, according to the reaction:

Ca²⁺₍ₛₒₗᵤₜᵢₒₙ₎+Na₂CO₃₍ₛₒₗᵤₜᵢₒₙ₎→CaCO_{3(g)}↓+2Na⁺₍ₛₒₗᵤₜᵢₒₙ₎ (30)

The resulting Ca(OH)₂ precipitate with an admixture of CaCO₃ is directed to the process of chlorination of the Ca(OH)₂ pulp. The solution formed after calcium precipitation and containing active chlorine in equal proportions is returned to the process of chlorination of NaOH solution and Ca(OH)₂ pulp.

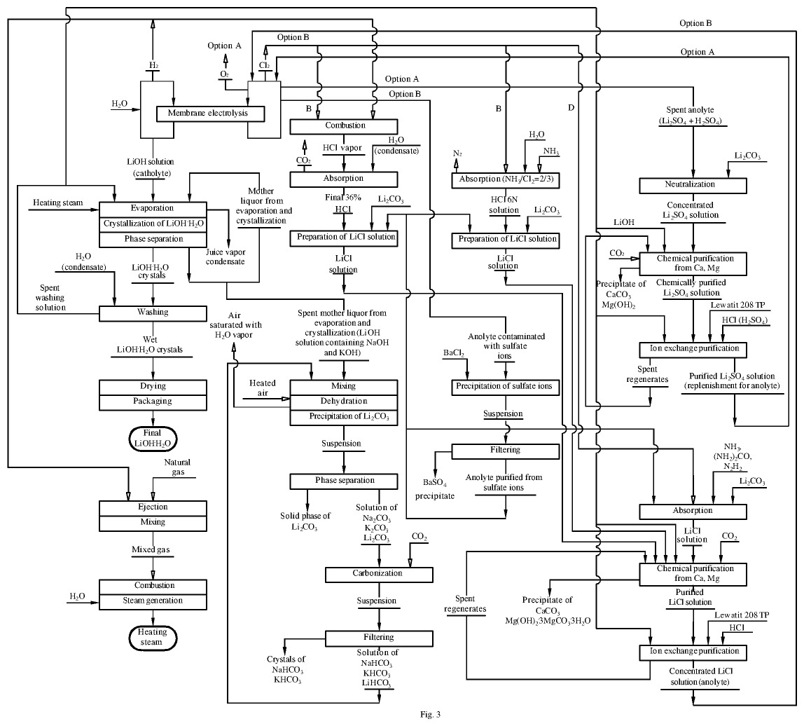

A process flow diagram of the production of LiOH·H₂O from a material containing a lithium salt in the form of the Li₂CO₃ salt is shown on FIG. 3. As follows from the scheme, the utilization of Li₂CO₃ salt for the preparation of LiOH·H₂O consists in using this salt as a reagent for the reproduction of an anolyte depleted of lithium in the membrane electrolysis process, circulating either in the form of a Li₂SO₄ solution (option A) or in the form of a LiCl solution (options B, C). Herewith, according to option A, the spent anolyte is strengthened with lithium simultaneously with the complete neutralization of sulfuric acid by mixing it with a predetermined amount of the initial lithium carbonate salt, including lithium carbonate obtained by recycling the spent catholyte subjected to evaporation; according to this option cathodic hydrogen is used as a flue gas component for the generation of the heating steam. In case the production process follows option B, cathodic hydrogen and anodic chlorine are used to obtain concentrated hydrochloric acid by burning their mixture and performing absorption of hydrogen chloride by water (reaction 23). The resulting acid is mixed with the anolyte stream purified from sulfate ions which in turn is withdrawn from the circulating anolyte stream enriched in sulfate ions during electrolysis at a predetermined volumetric flow rate. A mixed solution of concentrated hydrochloric acid and anolyte purified from sulfate ions is brought into contact with a predetermined amount of the initial Li₂CO₃ salt and demineralized water to produce a LiCl solution of a predetermined concentration, which, after purification from calcium and magnesium, is used as a solution replenishing with LiCl for the circulating anolyte stream in the membrane electrolysis process. According to option B, anodic chlorine mixed with ammonia at a molar ratio of NH₃:Cl₂=2:3 is absorbed by demineralized water to produce a 6N hydrochloric acid solution (reaction 25). The resulting acid is mixed with the anolyte stream purified from sulfate ions which in turn is withdrawn from the circulating anolyte stream enriched in sulfate ions during electrolysis at a given volumetric flow rate. A mixed solution of hydrochloric acid and anolyte purified from sulfate ions is brought into contact with a predetermined amount of the initial Li₂CO₃ salt to produce a LiCl solution of a predetermined concentration, which, after purification from calcium and magnesium, is used as a replenishing solution for the circulating anolyte in the membrane electrolysis process; cathodic hydrogen according to this option is used as a fuel for the generation of the heating steam. According to option B, in the presence of a predetermined amount of a reducing agent the material composition of which prevents contamination of the absorbent, for example, ammonia, hydrazine, hydroxylamine, carbamide, formic acid, a LiCl solution is produced according to the reaction:

3 Cl_{2(g)}+3Li₂CO₃₍ₛ₎+2NH_{3(g)}→6 LiCl₍ₛₒₗᵤₜᵢₒₙ₎+N_{2(g)}+3CO_{2(g)}+3 H₂O₍ₗ₎ (31)

The aqueous pulp for the absorption of anodic chlorine is prepared from demineralized water, lithium carbonate obtained from the spent evaporated lithium catholyte in the form of initial Li₂CO₃ salt, an appropriate reducing agent, and an anolyte stream purified from sulfate ions which in turn is withdrawn from the circulating anolyte stream enriched in sulfate ions during electrolysis at a predetermined volumetric rate. Cathodic hydrogen according to this option is used as a fuel for the generation of the heating steam.

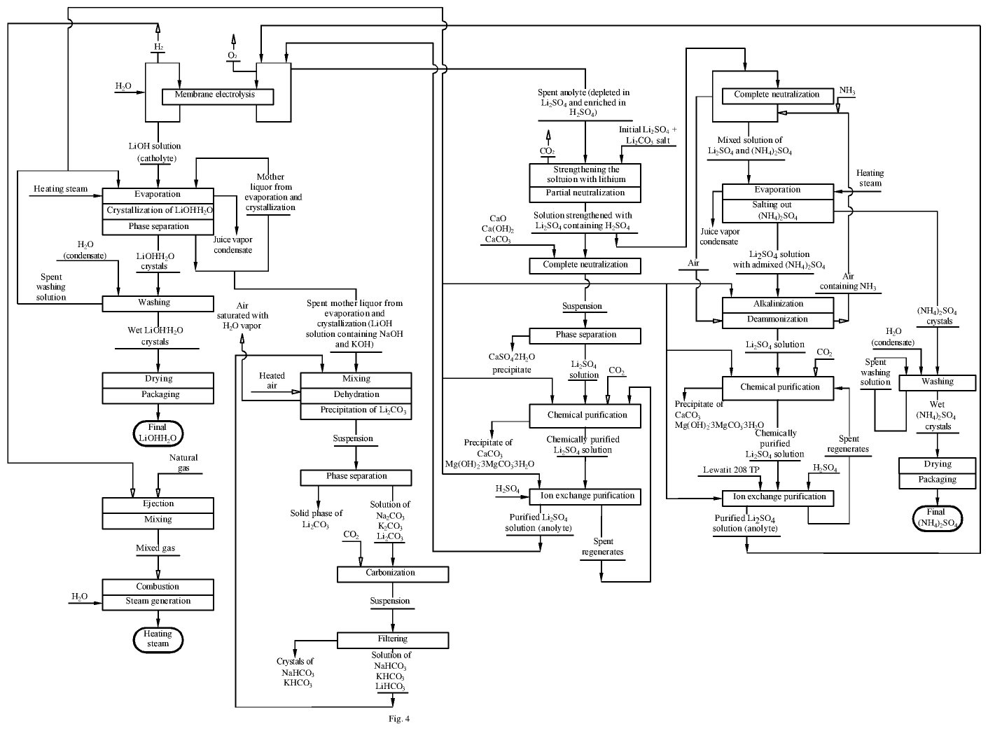

A process flow diagram of the production of LiOH·H₂O from a material containing a lithium salt in the form of a mixture of Li₂SO₄ and Li₂CO₃ is shown on FIG. 4. This flow diagram is substantially the same as the flow diagram shown on FIG. 1. The difference consists in that the strengthening (enrichment in lithium) of the spent anolyte to a predetermined lithium concentration therein is carried out by dissolving a predetermined amount of the initial mixed salt of Li₂SO₄ and Li₂CO₃ before the conducting the procedure of complete neutralization of sulfuric acid. Otherwise, the flow diagrams are identical.

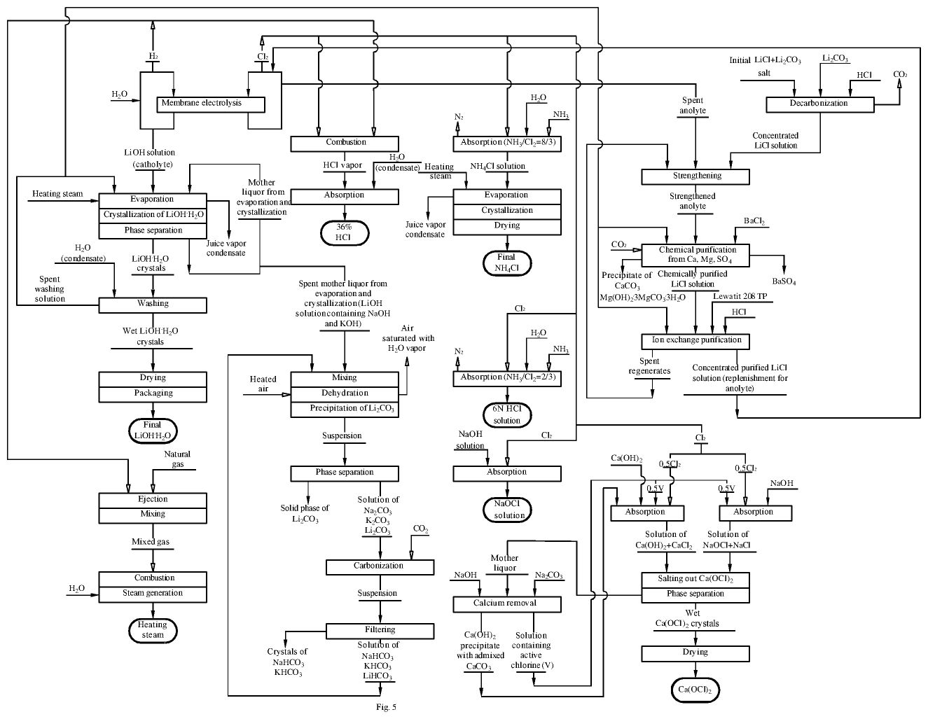

A process flow diagram of the production of LiOH·H₂O from materials containing a lithium salt in the form of a mixture of LiCl and Li₂CO₃ is shown on FIG. 5. This flow diagram is substantially the same as the flow diagram shown on FIG. 2. The difference consists in that the strengthening of the spent (lithium-enriched) anolyte is carried out by mixing it with a concentrated LiCl solution obtained by means of decarbonization with hydrochloric acid of the initial mixed salt of LiCl and Li₂CO₃ and carbonate obtained upon recycling the spent evaporated catholyte. Otherwise, the flow diagrams are identical.

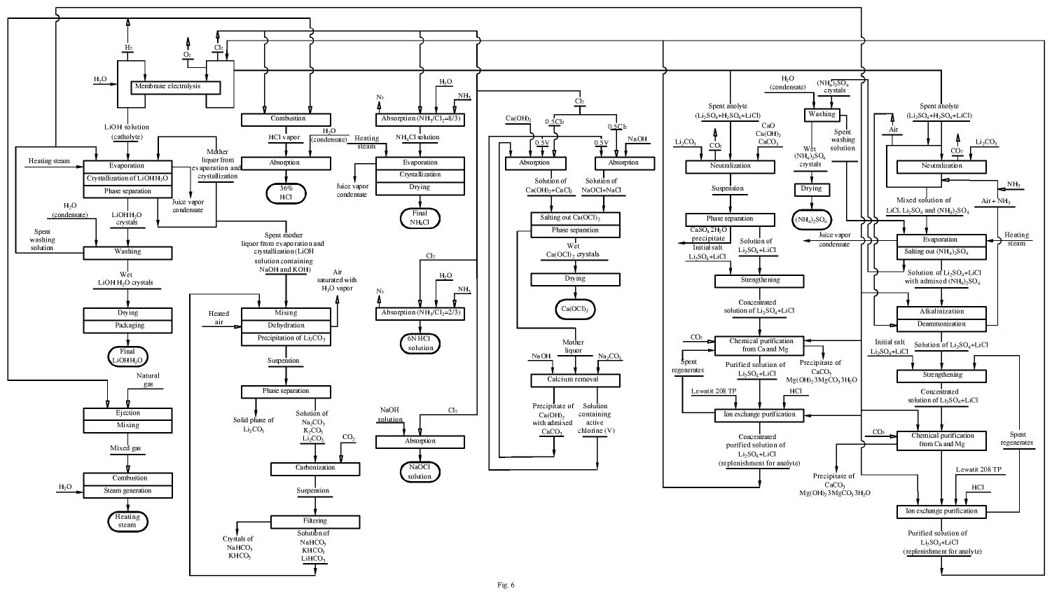

A process flow diagram of the production of LiOH·H₂O from materials containing a lithium salt in the form of a mixture of Li₂SO₄ and LiCl is shown on FIG. 6. A distinctive feature of this technology is that two highly soluble lithium salts, lithium chloride and lithium sulfate, are simultaneously involved in the anodic process, reactions (1) and (21) simultaneously occur at the anodes to simultaneously form H₂SO₄, Cl₂ and O₂ in the anode compartment. For this reason, the reliability of the membrane electrolysis process of the mixed salt is ensured by means of anodes made of platinized titanium. Herewith the cathodic process remains unchanged, occurring exactly as in the case of membrane electrolysis of the solutions of highly soluble Li₂SO₄ and LiCl salts.

Preparation of LiOH·H₂O based on the electrochemical conversion of mixed solutions of Li₂SO₄ and LiCl does not require a special process for purifying the anolyte from sulfate ions. Otherwise, the technology described on FIG. 6 is a combination of the process steps from the flow diagrams of FIG. 1 and FIG. 2.

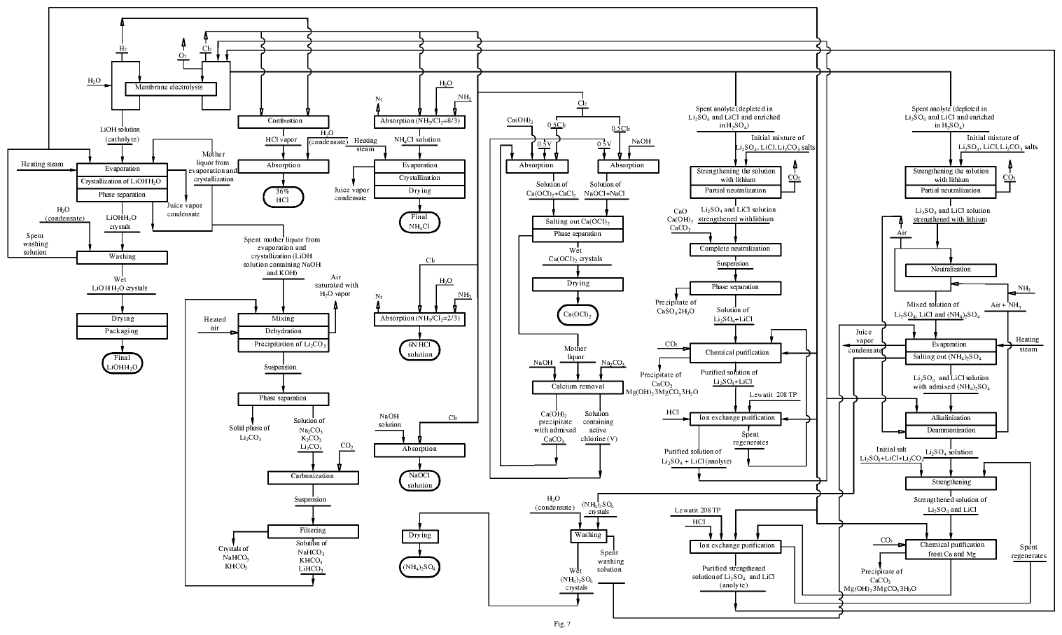

A process flow diagram of the production of LiOH·H₂O from materials containing a lithium salt in the form of a mixture of Li₂SO₄, LiCl and Li₂CO₃ is shown on FIG. 7. This flow diagram differs from the flow diagram of processing the mixed salt of Li₂SO₄ and LiCl (FIG. 6) only in that the process of strengthening the spent anolyte is carried out before the procedure of sulfuric acid neutralization. Otherwise, the flow diagrams are identical.

### EXAMPLE 1

A laboratory scale apparatus containing a membrane electrolysis unit, a unit for processing catholyte into LiOH·H₂O, a unit for pretreating and purifying the replenishing lithium salt solution for feeding into the circulating anolyte, a unit for processing the spent evaporated catholyte, and an anodic gas utilization unit was used to carry out comparative tests of technological processes for producing LiOH·H₂O from various lithium salts: lithium sulfate, lithium chloride, a mixture of sulfate and lithium chloride. The technological processes reproduced on the laboratory apparatus were carried out on the basis of the flow diagram shown on FIGS. 1, 2. Herewith the sulfate-containing anolyte was neutralized following the option of using slaked lime for this purpose, the chloride-containing anolyte was strengthened with lithium carbonate previously dissolved in hydrochloric acid, and the anodic chlorine was utilized as neutral calcium hypochlorite. The following lithium salts were used for testing: technical grade lithium sulfate monohydrate (the composition is shown in Table 1) and lithium chloride according to TU2152-017-07622236-2015 (the composition is shown in Table 2)

TABLE 1
Composition of technical grade Li₂SO₄ · H₂O

| Parameter name | Content, wt. % |
|---|---|
| Mass fraction of Li₂SO₄ · H₂O | 98.10 |
| Li₃PO₄ | 1.90 |
| Na | 0.020 |
| K | 0.003 |
| Ca | 0.0064 |
| Mg | 0.0002 |
| Fe | 0.0005 |
| water | 10.5 |
| Cl + Fe | not detected |

TABLE 2
Composition of technical grade LiCl · H₂O

| Parameter name | Content, wt. % |
|---|---|
| Na + K | 0.1 |
| Ca + Mg | 0.03 |
| Fe | 0.005 |
| Al | 0.01 |
| Pb | 0.003 |
| PO₄ | 0.007 |
| SO₄ | 0.1 |
| OH | 0.03 |

Calcium hydroxide used for neutralizing sulfuric acid and utilizing anodic chlorine as neutral calcium hypochlorite was obtained by precipitation (with NaOH as the precipitant) from a solution of CaCl₂ produced by dissolving hydrated technical grade CaCl₂·6H₂O salt.

The main comparative parameters and characteristics of LiOH·H₂O production technologies from various lithium salts according to the claimed method are shown in Table 3. The compositions of the respective resulting LiOH·H₂O samples are shown in Table 4.

TABLE 3
Comparative characteristics of technological processes for producing
LiOH · H₂O from various lithium salts according to the claimed method

| The main parameters of the | The solution used to replenish the anolyte | | |
|---|---|---|---|
| LiOH · H₂O production | Li₂SO₄ solution | LiCl | Li₂SO₄ + LiCl |
| Current density, A/dm³ | 30 | 30 | 30 |
| LiOH current output, % | 59.8 | 60.6 | 60.1 |
| Membrane type | CTIEM-3 | CTIEM-3 | CTIEM-3 |
| Cathode material | nickel-plated | nickel-plated | nickel-plated |
| | stainless steel | stainless steel | stainless steel |
| Anode material | platinized titanium | titanium coated | platinized titanium |
| | | with ruthenium | |
| | | oxide (ORTA) | |
| Material quantitative | Li₂SO₄ - 205.6 | LiCl - 217.6 | Li₂SO₄ - 147.9 |
| composition of the anolyte, | H₂SO₄ - 38.7 | pH = 1.5 | LiCl - 102.3 |
| g/dm³ | | | H₂SO₄ - 20.5 |
| Concentration of LiOH in the | 48.8 | 49.4 | 49.1 |
| catholyte, g/dm³ | | | |
| Chlorine current output, % | — | 97.0 | 96.8 |
| Composition of the spent | LiOH- 120 | LiOH- 120 | LiOH- 120 |
| catholyte from the evaporation | (NaOH + KOH) - 8.7 | (NaOH + KOH) - 9.1 | (NaOH + KOH) - 8.2 |
| and crystallization process, | | | |
| g/dm³ | | | |
| Recovery of LiOH in the final | 96.7 | 90.1 | 97.4 |
| product from LiOH conversion | | | |
| solution | | | |
| The degree of separation of | 99.97 | 99.90 | 99.93 |
| lithium and alkali (Na + K) | | | |
| during the recycling of spent | | | |
| catholyte from the evaporation | | | |
| and crystallization process | | | |

TABLE 4
Compositions of LiOH · H₂O samples obtained
from various lithium salts by the claimed method

| Parameter | Composition, wt. %, of LiOH · H₂O samples obtained from lithium salts | | |
|---|---|---|---|
| name | Li₂SO₄ · H₂O | LiCl · H₂O | Li₂SO₄ · H₂O and LiCl · H₂O |
| LiOH | 56.72 | 56.70 | 56.73 |
| Carbonates (CO₃²⁻) | 0.36 | 0.32 | 0.30 |
| Na + K | less than 0.002 | less than 0.002 | less than 0.002 |
| Ca + Mg | less than 0.001 | less than 0.001 | less than 0.001 |
| Al | less than 0.003 | less than 0.003 | less than 0.003 |
| Fe | less than 0.0005 | less than 0.0005 | less than 0.0005 |
| Si | less than 0.001 | less than 0.001 | less than 0.001 |
| Pb | less than 0.0005 | less than 0.0005 | less than 0.0005 |
| Cl | less than 0.005 | less than 0.015 | less than 0.010 |
| SO₄ | 0.015 | less than 0.01 | less than 0.01 |
| PO₄ | less than 0.005 | less than 0.0005 | less than 0.0005 |

As follows from the results, the claimed method allows producing a high-quality LiOH·H₂O product which meets the requirements of the LGO-1 GOST 8595-83 grade from the tested lithium salts. Herewith the electrochemical parameters of membrane electrolysis conversion processes of solutions of highly soluble lithium salts into a LiOH solution have almost similar characteristics.

The tests also showed that when anodic chlorine is utilized according to the option proposed in the claimed method, which involves recycling the anodic chlorine into neutral calcium hypochlorite, the content of active chlorine in the samples of the produced product is 62-63 wt. % with the content of water-insoluble impurities not exceeding 4.3%. The degree of utilization of the anodic chlorine is 99.7%.

The tests in turn showed that the neutralization of sulfuric acid in spent sulfuric acid anolytes should be carried out by adding a stoichiometric amount of Ca(OH)₂, provided that this operation is carried out in two steps to completely neutralize H₂SO₄ in the anolyte without the need to introduce excess Ca(OH)₂.

Herewith at the first step contacting of the initial spent anolyte with the spent precipitate from the second step, which is a mixture of CaSO₄·2 H₂O and Ca(OH)₂, takes place with guaranteed conversion of all free Ca(OH)₂ into CaSO₄·2 H₂O and the withdrawal of the resulting CaSO₄·2 H₂O precipitate by filtration. The filtrate containing the unreacted H₂SO₄ residue is brought into contact with Ca(OH)₂ taken in a stoichiometric ratio to the H₂SO₄ contained in the initial spent anolyte fed to the first neutralization step. During contacting of the phases at the second step a mixed precipitate of CaSO₄·2 H₂O and Ca(OH)₂ is formed and complete neutralization of sulfuric acid is ensured. The contacting of the anolyte with Ca(OH)₂ is carried out under conditions of vigorous mixing.

### EXAMPLE 2

A laboratory bench including three membrane electrolysis units was used for the testing of the three cation-exchange membranes, Nafion-438, CTIEM-3, and MF-4SK-100, for their suitability for the electrochemical conversion of Li₂SO₄ and LiCl solutions into a LiOH solution. The total test period was 219 work hours. The following were tested as the anodes: for the electrolysis of LiCl solutions—titanium coated with ruthenium oxide (ORTA), for the electrolysis of Li₂SO₄ solutions—platinized titanium. The results are shown in Table 5.

TABLE 5
The results of testing various cation-exchange membranes with respect to electrochemical
conversion of Li₂SO₄ and LiCl solutions into a LiOH solution

| | Solution used for conversion | | | | | |
|---|---|---|---|---|---|---|
| | Aqueous Li₂SO₄ solution | | | Aqueous LiCl solution | | |
| Main parameters | Nafion-438 | CTIEM-3 | MF-4SK-100 | Nafion-438 | CTIEM-3 | MF-4SK-100 |
| Current density, | 30.0 | 30.0 | 30.0 | 35.0 | 35.0 | 35.0 |
| A/dm² | | | | | | |
| Cell voltage - | 4.9 | 5.0 | 5.0 | 3.3 | 4.0 | 4.0 |
| the beginning of | | | | | | |
| testing | | | | | | |
| Composition of the | Li₂SO₄ -200 | Li₂SO₄ -200 | Li₂SO₄ -200 | LiCl - 220 | LiCl - 220 | LiCl - 220 |
| anolyte, g/dm3 | H₂SO₄ -60 | H₂SO₄ -60 | H₂SO₄ -60 | pH - 2.0 | pH - 2.0 | pH - 2.0 |
| Catholyte | LiOH-65 | LiOH-65 | LiOH-65 | LiOH-70 | LiOH-70 | LiOH-70 |
| composition, g/dm³ | NaOH- 0.060 | NaOH- 0.061 | NaOH- 0.062 | NaOH- 0.31 | NaOH- 0.30 | NaOH- 0.31 |
| Anolyte | 65-70 | 65-70 | 65-70 | 80-85 | 80-85 | 80-85 |
| temperature, ° C. | | | | | | |
| Linear travel speed | 36 | 36 | 36 | 36 | 36 | 36 |
| of electrolytes in | | | | | | |
| gas separators (gas | | | | | | |
| purifiers), m/h | | | | | | |
| Alkali current | | | | | | |
| output | | | | | | |
| the beginning of | 60.5 | 60.0 | 59.6 | 60.5 | 60.0 | 59.7 |
| testing | | | | | | |
| the end of testing | 60.7 | 60.0 | 59.6 | 60.4 | 60.0 | 59.6 |

As follows from the results, all tested membranes are suitable for membrane electrolysis of sulfate and chloride lithium solutions to obtain a catholyte in the form of a LiOH solution. Herewith such parameters of membrane electrolysis as the cell voltage and the LiOH current output for the tested membranes are virtually commensurate. The tests also showed that the electrolysis of LiCl solutions to obtain a LiOH solution is less energy consuming, since the voltage on the cells of membrane electrolysis units during the electrolysis of a sulfate solution is always higher than during the electrolysis of a chloride-containing solution. This finding is attributed to the higher electrical conductivity of Li₂SO₄ solutions in comparison to LiCl solutions.

It follows from the obtained data that other cation-exchange membranes can be used for the conversion of Li₂SO₄ and LiCl solutions, equivalent to the tested ones and chemically stable in these media.

### EXAMPLE 3

A laboratory apparatus made in accordance with the flow diagram shown on FIG. 3 was used for testing the technology for producing LiOH·H₂O from lithium carbonate by using it for the reproduction of LiCl and Li₂SO₄ fed to the anolyte circulation circuits for replenishment in the processes of membrane electrolysis of LiCl and Li₂SO₄ solutions from of the spent electrolytes depleted in LiCl and Li₂SO₄ withdrawn from the electrolysis process. Herewith this reproduction of the replenishing Li₂SO₄ solution was carried out by directly contacting a predetermined amount of Li₂CO₃ with the spent anolyte at the step of neutralization of the spent sulfate-containing anolyte. Reproduction of the replenishing LiCl solution was carried out according to two options. According to the first option, anodic chlorine was absorbed as part of a mixture with ammonia (molar ratio of NH₃:Cl₂=2:3) by demineralized water to obtain a hydrochloric acid solution of a predetermined concentration, which was brought into contact with a predetermined amount of Li₂CO₃, the resulting solution was mixed with the spent anolyte previously neutralized to pH=7 with lithium carbonate to obtain a lithium chloride solution strengthened with LiCl that was used for replenishing the circulating anolyte in the membrane electrolysis process. According to the second option, anodic chlorine was absorbed by a lithium carbonate pulp with a predetermined content of Li₂CO₃ in the presence of a predetermined amount of carbamide reducing agent to obtain a LiCl solution of a predetermined concentration, which was mixed with the spent anolyte previously neutralized to pH=7 with lithium carbonate to obtain a lithium chloride solution strengthened with LiCl that was used for replenishing the circulating anolyte. Technical grade lithium carbonate produced by SQM (Chile) was used as the initial carbonate, the composition thereof is shown in Table 6.

TABLE 6
Composition of the technical grade lithium carbonate used

| | Substance (element) | | | | | | | | | |
|---|---|---|---|---|---|---|---|---|---|---|
| | | | | | | | | | insoluble | |
| | Li₂CO₃ | Cl | Na | K | Ca | Mg | SO₄ | Fe₂O₃ | residue | LOI |
| Content, | 99.0 | 0.020 | 0.120 | 0.050 | 0.04 | 0.011 | 0.100 | 0.030 | 0.020 | 0.700 |
| wt. % | | | | | | | | | | |

The strengthened and purified salt solutions of lithium produced from spent anolyte streams were adjusted to the predetermined concentrations of Li₂SO₄ and LiCl in replenishing solutions by evaporation. The main parameters of the tests performed are shown in table 7. The compositions of the respective resulting LiOH·H₂O samples are shown in table 8. It can clearly be seen from the results obtained that the proposed method allows producing LiOH·H₂O as a product of high purity meeting the requirements of the LGO-1 grade from the technical grade lithium carbonate.

TABLE 7
The main parameters of the production of LiOH · H₂O from
Li₂CO₃ by means of membrane electrolysis of highly soluble lithium salts

| | Production of LiOH · H₂O from Li₂CO₃ by means of | |
|---|---|---|
| | membrane electrolysis of highly soluble lithium salts | |
| Main parameters | Li₂SO₄ salt solution | LiCl salt solution |
| Current density, A/dm² | 30.0 | 30.0 |
| Composition of the anolyte, g/dm³ | Li₂SO₄ - 204 | LiCl - 222 |
| | H₂SO₄ - 63 | |
| Composition of the catholyte, g/dm³ | LiOH - 48.3 | LiOH - 48.7 |
| | NaOH - 0.13 | NaOH - 0.14 |
| Temperature of electrolytes, ° C. | 67 | 86 |
| LiOH current output, % | 60.0 | 60.7 |
| Recovery of LiOH in the final product | 95.9 | 95.9 |
| from LiOH conversion solution, % | | |
| Membrane type | CTIEM-3 | CTIEM-3 |
| Anode type | platinized titanium | titanium coated with |
| | | ruthenium oxide (ORTA) |
| Concentration of HCl produced from | — | 219.1 |
| anodic chlorine, g/dm³ | | |
| Concentration of the LiCl solution | — | 255.1 |
| produced from Li₂CO₃ and HCl, g/dm³ | | |
| Concentration of the LiCl solution | — | 253.4 |
| produced by the absorption of anodic | | |
| chlorine by the lithium carbonate pulp, | | |
| in the presence of a reducing agent, g/dm³ | | |
| Concentration of lithium salt in the | (Li₂SO₄) | (LiCl) |
| purified LiCl solution fed to replenish | 311 | 328 |
| the circulating anolyte, g/dm³ | | |

TABLE 8
Compositions of LiOH · H₂O samples produced from Li₂CO₃
by means of membrane electrolysis of highly soluble lithium salts

| | Composition, wt. %, of LiOH · H₂O samples | |
|---|---|---|
| | produced from Li₂CO₃ by means of membrane | |
| | electrolysis of highly soluble lithium salts solutions | |
| Parameter name | Li₂SO₄ | LiCl |
| LiOH | 56.71 | 56.70 |
| carbonates (CO₃²⁻) | 0.34 | 0.31 |
| Na + K | less than 0.002 | less than 0.002 |
| Ca + Mg | less than 0.001 | less than 0.001 |
| Al | less than 0.003 | less than 0.003 |
| Fe | less than 0.0005 | less than 0.0005 |
| Si | less than 0.001 | less than 0.001 |
| Pb | less than 0.0005 | less than 0.0005 |
| Cl | less than 0.001 | 0.013 |
| SO₄ | 0.014 | less than 0.010 |
| PO₄ | not detected | not detected |

Herewith the recovery of conversion alkali (LiOH solution) as a solid product (LiOH·H₂O) significantly depends on the content of sodium and potassium in the initial lithium carbonate.

### EXAMPLE 4

A laboratory bench represented by an assembly for the utilization of sulfate ions present in the H₂SO₄ salt was used for the testing the utilization option by converting the sulfuric acid contained in the spent sulfate anolyte into a (NH₄)₂SO₄ salt by contacting the spent anolyte with ammonia and salting out the (NH₄)₂SO₄ salt from a mixed spent solution of Li₂SO₄ and (NH₄)₂SO₄ during its evaporation accompanied by increasing the concentration of Li₂SO₄ in the anolyte. The option of the technological process for the utilization of sulfuric acid contained in the spent anolyte in the form of (NH₄)₂SO₄ salt is shown on FIG. 1. The results obtained are shown in Table 9.

TABLE 9
The main parameters of the process of recycling the anodic sulfuric
acid contained in the spent sulfate anolyte into (NH₄)₂SO₄ salts

| | Values of |
|---|---|
| Main parameters | parameters |
| Composition of the spent sulfate anolyte, | Li₂SO₄ - 201.3 |
| g/dm₃ | H₂SO₄ - 60.4 |
| Composition of the spent anolyte following | Li₂SO₄ - 201.8 |
| contacting with ammonia, g/dm³ | (NH₄)₂SO₄ - 81.3 |
| Composition of lithium ammonium sulfate | Li₂SO₄ - 261.3 |
| solution | |
| following evaporation and salting out | (NH₄)₂SO₄ - 9.4 |
| of (NH₄)₂SO₄, g/dm³ | |
| Composition of the sulfate solution after | Li₂SO₄ - 269.1 |
| alkalinization and aeration, g/dm³ | (NH₄)₂SO₄ < 0.05 |

The resulting samples of the (NH₄)₂SO₄ salt after 3-step countercurrent washing with demineralized water and drying at 110° C. contained the main substance in the form of (NH₄)₂SO₄ at 99.7% wt. with the content of lithium impurities of less than 0.002 wt. %. Herewith the degree of ammonia utilization was 99.84%.

### EXAMPLE 5

The spent catholyte stream of 10 dm³ having the following composition (g/dm³): LiOH—120; NaOH—8.7; KOH—0.3, was recycled according to the claimed method (FIG. 1-FIG. 7) on an apparatus brought to working conditions in steady state. The recycling resulted in 1850 g of dry Li₂CO₃ with the main substance content of 99.9% and a total sodium and potassium impurity content of less than 0.01%. The total weight of the dry precipitate of the NaHCO₃ and KHCO₃ salt obtained was 188.1 g with a residual lithium content of less than 0.002%.

### REFERENCES

1. RU patent No. 2071819, published on 20 Jan. 1997
2. WO application Zealand No. 9859385, published on 1998
3. RU patent No. 2157338, published on 10 Oct. 2000
4. RU patent No. 21967335, published on 20 Jan. 2003
5. RU patent No. 2656452, published on 5 Jun. 2018

What is claimed is:

1. A method for producing high purity lithium hydroxide monohydrate from materials containing a lithium salt selected from lithium sulfate, lithium chloride, lithium chloride monohydrate, lithium carbonate, or mixtures thereof, the method comprising:
performing membrane electrolysis of an aqueous solution of the lithium salt using a cation-exchange membrane as the membrane separating cathode and anode circuits of electromagnetic cells in the mode of circulation of the catholyte in the form of a solution of lithium hydroxide and anolyte in the form of a lithium salt solution, wherein a cathode for the membrane electrolysis is made of nickel-plated stainless steel and the cation-exchange membrane is selected from a membrane resistant to alkalis and acids;
withdrawing a volume of the catholyte from a circulating catholyte stream and evaporating the withdrawn volume of the catholyte to obtain crystals of lithium hydroxide monohydrate in a mother liquor;
separating the crystals from the mother liquor, washing the crystals with water and drying the washed crystals to obtain final high purity lithium hydroxide monohydrate;
wherein the method is further characterized by the following steps:
removing cathodic and anodic gases formed during the electrolysis;
feeding a part of a resulting stream of spent washing solution to a catholyte evaporation process and using part of the spent washing solution fed to the catholyte evaporation process in recycling of withdrawn spent anolyte stream;
returning a part of the mother liquor formed after separation of the crystals of lithium hydroxide monohydrate to the catholyte evaporation process;
recycling a part of the spent catholyte stream, which is withdrawn from the evaporation process and represents a concentrated solution of lithium hydroxide with an admixture of sodium and potassium hydroxides;
replenishment of a circulating anolyte stream with a concentrated solution of a lithium salt prepared from an original source of lithium salt and a solution of a lithium salt obtained as a result of the recycling the withdrawn spent anolyte stream.

2. The method according to claim 1, wherein recycling the spent catholyte stream comprises: mixing the concentrated solution of lithium hydroxide with the admixture of sodium and potassium hydroxides with a stream of an aqueous solution containing sodium, potassium and lithium bicarbonates, to obtain lithium carbonate; concentrating a resulting pulp represented by a mixture of solid phase of lithium carbonate and a carbonate solution containing Na₂CO₃, K₂CO₃, Li₂CO₃ by removing water; separating the solid phase of lithium carbonate from the carbonate solution liquid phase, carbonizing the carbonate solution liquid phase by directly contacting it with carbon dioxide to convert the carbonate solution into a bicarbonate suspension comprising a mixture of solid phases of sodium bicarbonate and potassium bicarbonate in a solution of sodium, potassium and lithium bicarbonates; filtering the bicarbonate suspension to separate the solid phase of sodium and potassium bicarbonates from a solution containing sodium, potassium and lithium bicarbonates, which is directed to mixing with the stream of spent catholyte withdrawn from the process of evaporation containing lithium, sodium and potassium hydroxides.

3. The method according to claim 1, wherein using part of the spent washing solution fed to the catholyte evaporation process in the recycling of the withdrawn spent anolyte stream comprises using the spent washing solution as an alkaline reagent at a step of chemical purification of the lithium salt solution from impurities and/or as a regenerating solution for converting the ion exchanger from H-form to Li-form at a step of ion exchange purification.

4. The method according to claim 3, wherein the concentrated solution of lithium salts has a direct current density of 1-4 kA/m²; the cation-exchange membrane for the membrane electrolysis is a membrane of Nafion-438, CTIEM-3, or MF-4SK-100 types; and an ion exchanger is used at the step of ion exchange purification.

5. The method according to claim 4, wherein when lithium sulfate is used as the material containing lithium salt, titanium coated with noble metals selected from platinum, iridium, ruthenium or tantalum, is used as an anode in the performing membrane electrolysis step, and an anolyte stream is constantly withdrawn from the circulating anolyte stream undergoing depletion in Li₂SO₄ and enrichment in H₂SO₄; neutralizing the withdrawn anolyte stream by bringing into contact with CaO, Ca(OH)₂, or CaCO₃ until H₂SO₄ is completely neutralized; a resulting solid phase of CaSO₄·2H₂O is separated from a Li₂SO₄ solution, the Li₂SO₄ solution is brought into contact with initial lithium sulfate salt to dissolve the initial lithium sulfate salt and to obtain a lithium sulfate solution; the lithium sulfate solution is added with the spent washing solution forming a mixed lithium sulfate solution followed by carbonizing the mixed solution with carbon dioxide coming from the process of neutralization of the withdrawn anolyte stream until calcium and magnesium contained in the mixed lithium sulfate solution are converted into insoluble compounds CaCO₃ and Mg(OH)₂·3MgCO₃·3H₂O forming a suspension; the suspension is filtered to separate the insoluble compounds from the mixed lithium solution forming a chemically purified Li₂SO₄ solution, the chemically purified Li₂SO₄ solution is directed to ion exchange purification by passing the chemically purified Li₂SO₄ solution through a layer of ion exchanger in Li-form producing an Li₂SO₄ solution that has undergone ion exchange purification; the Li₂SO₄ solution that has undergone ion exchange purification is used as a replenishing solution for the circulating anolyte stream in the membrane electrolysis process; regenerating spent ion exchanger in two steps: the first step comprises treatment with 2.0N sulfuric acid solution, the second step comprises treatment with 2.0N LiOH solution; the spent regenerates from the ion exchange process are mixed with the spent anolyte stream before its chemical purification; cathodic hydrogen, obtained from the membrane electrolysis, is ejected with a natural gas stream from the cathode gas separator of the electrolysis unit providing a gaseous mixture, the gaseous mixture is directed to a steam generator as fuel for the generation of a heating steam used as a heat carrier in an evaporation step.

6. The method according to claim 5, wherein a volume of the anolyte constantly withdrawn from the circulating anolyte stream undergoing depletion in Li₂SO₄ and enrichment in H₂SO₄ is brought into contact with an air-ammonia mixture to neutralize H₂SO₄ and obtain a mixed solution of Li₂SO₄ and (NH₄)₂SO₄ which is evaporated to salt out (NH₄)₂SO₄ and increase the concentration of Li₂SO₄ in an evaporated solution; the evaporated solution with remaining (NH₄)₂SO₄ is mixed with a volume of the spent alkaline washing solution to produce a mixed solution, and the mixed solution is brought into contact with an air stream coming from the process of contacting the spent anolyte stream with the ammonia-air mixture to remove the remaining ammonia from the Li₂SO₄ solution producing a gaseous ammonia containing air stream and an ammonia-free Li₂SO₄ solution; the gaseous ammonia containing air stream is enriched with ammonia from an ammonia source and directed to the step of neutralizing the spent anolyte stream; the ammonia-free Li₂SO₄ solution after strengthening with Li₂SO₄ by dissolving therein the initial Li₂SO₄ salt and purification from impurities is used as a replenishing solution for the circulating anolyte stream in the membrane electrolysis process.

7. The method according to claim 4, wherein when lithium chloride or lithium chloride monohydrate is used as the lithium salt containing material, titanium anodes coated with a ruthenium oxide are used in the membrane electrolysis process, and a volume of the anolyte is constantly withdrawn from the circulating anolyte stream undergoing depletion in LiCl providing a withdrawn anolyte stream; the withdrawn anolyte stream is brought into contact with the initial lithium chloride salt to bring the LiCl concentration in the withdrawn anolyte stream to a predetermined value providing a withdrawn anolyte stream; purifying the withdrawn LiCl-enriched anolyte stream from metal cation impurities and adding barium chloride to the withdrawn LiCl-enriched anolyte stream to convert sulfate ions into an insoluble BaSO₄ precipitate producing a withdrawn LiCl-enriched anolyte stream purified from metal cation impurities and sulfate ions, a liquid phase of the withdrawn LiCl-enriched anolyte stream purified from metal cation impurities and sulfate ions is separated from precipitates and, following an ion exchange purification, is used as a replenishing solution in the circulating anolyte stream in the membrane electrolysis process; cathodic hydrogen and anodic chlorine withdrawn from gas separators are mixed and subjected to flame combustion;
the resulting hydrogen chloride is absorbed by demineralized water to produce concentrated 36% hydrochloric acid.

8. The method according to claim 7, wherein the anodic chlorine withdrawn from a gas separator of the gas separators is absorbed by aqueous ammonia to produce, at a molar ratio of NH₃:Cl₂=8:3, a NH₄Cl solution, and at a molar ratio of NH₃:Cl₂=2:3, a 6N HCl solution; the resulting NH₄Cl solution is evaporated, NH₄Cl is crystallized and dried, the cathodic hydrogen withdrawn from a gas separator of the gas separators is utilized as a heat carrier for generation of heating steam.

9. The method according to claim 7, wherein either all anodic chlorine withdrawn from the gas separator is absorbed by a NaOH solution to produce a disinfecting solution of sodium hypochlorite, or half of the withdrawn volumetric flow of chlorine is absorbed by a NaOH solution to produce a solution saturated with sodium hypochlorite, and the other half of the withdrawn volumetric flow of anodic chlorine is absorbed by a Ca(OH)₂ suspension to produce a solution saturated with calcium hypochlorite; the produced solutions are mixed to salt out neutral calcium hypochlorite which is separated and dried; calcium is precipitated out of a resulting mother liquor, first by adding a predetermined amount of NaOH, and then by adding Na₂CO₃; precipitate containing Ca(OH)₂ with an admixture of CaCO₃ is separated and directed to the preparation of Ca(OH)₂ suspension containing active chlorine in the form of hypochlorite ions; a remaining solution is divided into two equal portions, one portion is mixed with NaOH and directed to chlorination process to obtain a sodium hypochlorite solution, another portion is mixed with Ca(OH)₂ and is also directed to chlorination process to obtain a calcium hypochlorite solution.

10. The method according to claim 4, wherein when lithium carbonate is used as the lithium salt containing material, lithium carbonate salt is used for the reproduction of anolytes by converting Li₂CO₃ into highly soluble lithium salts lithium chloride or lithium sulfate, circulating as anolytes in the anode circuits of the electrolysis unit and undergoing depletion in LiCl or Li₂SO₄ during membrane electrolysis.

11. The method according to claim 4, wherein when an aqueous solution of lithium chloride is used as the anolyte, titanium anodes coated with ruthenium oxide are used in the membrane electrolysis process, wherein cathodic hydrogen and anodic chlorine are combusted after mixing to produce high-temperature hydrogen chloride vapor, the hydrogen chloride vapor is cooled and absorbed by demineralized water in a stepwise countercurrent mode to obtain a stream of a concentrated 36% hydrochloric acid withdrawn from a first absorption step along the path of the HCl vapor; a stream of resulting concentrated hydrochloric acid is mixed with a stream purified from sulfate ions using BaCl₂ as the reagent, withdrawn for purification from sulfate ions from the circulating anolyte stream in the membrane electrolysis process producing a mixed stream of concentrated hydrochloric acid and anolyte purified from sulfate ions; the mixed stream of concentrated hydrochloric acid and anolyte purified from sulfate ions is brought into contact with an initial lithium carbonate and demineralized water to obtain a stream of LiCl solution which, after being purified from calcium and magnesium impurities, is used as a replenishing solution for the circulating anolyte stream in the membrane electrolysis process.

12. The method according to claim 11, wherein anodic chlorine is absorbed by demineralized water in the presence of ammonia at a mole ratio of NH₃:Cl₂=2:3 to obtain a 6N hydrochloric acid solution, which is mixed with a stream of anolyte chemically purified withdrawn for purification from sulfate ions from the circulating anolyte stream in the membrane electrolysis process to produce a mixed stream of hydrochloric acid solution and the anolyte purified from sulfate ions; the mixed stream of hydrochloric acid solution and anolyte purified from sulfate ions is brought into contact with an initial lithium carbonate to obtain a LiCl solution stream, which, after being purified from calcium and magnesium impurities, is used as a replenishing solution for the circulating anolyte stream in the membrane electrolysis process, and the cathodic hydrogen is used as fuel for generation of heating steam.

13. The method according to claim 11, wherein the anodic chlorine is absorbed by an aqueous pulp of lithium carbonate and in the presence of a reducing agent for elemental chlorine, which prevents an absorber during chlorine absorption from being contaminated with foreign cations and anions and to obtain as an absorption product a lithium chloride solution, which after being purified from calcium and magnesium impurities is used as a replenishing solution for the circulating anolyte stream in the membrane electrolysis process, whereby the aqueous pulp for the absorption of the anodic chlorine is prepared from demineralized water, lithium carbonate obtained from the spent catholyte, lithium carbonate in the form of the initial salt, a reducing agent and the anolyte stream purified from sulfate ions using as the reagent, following withdrawal of the anolyte stream for purification from sulfate ions from the circulating anolyte stream in the membrane electrolysis process, and cathodic hydrogen is used as fuel for generation of heating steam.

14. The method according to claim 4, wherein when using an aqueous solution of lithium sulfate as the anolyte, titanium coated with noble metals selected from platinum, iridium, tantalum or ruthenium, is used as an anode in the electrolysis process, and an anolyte stream depleted in lithium sulfate and enriched in sulfuric acid, withdrawn from the anolyte circulation circuit, is brought into contact with an initial lithium carbonate to obtain a lithium sulfate solution, which, after purification from impurities, is used as a replenishing solution for the anolyte circulation circuit.

15. The method according to claim 4, wherein when a mixture of lithium sulfate and lithium carbonate is used as the lithium salt containing material, an anolyte stream of a predetermined volume is constantly withdrawn from the circulating anolyte stream undergoing depletion in Li₂SO₄ and enrichment in H₂SO₄; the withdrawn anolyte stream is brought into contact with an initial mixture of Li₂SO₄ and Li₂CO₃ salts to obtain a lithium sulfate solution containing a residual amount of H₂SO₄; the lithium sulfate solution containing the residual amount of H2SO4 is recycled into a Li₂SO₄ solution for replenishing the circulating anolyte stream in the membrane electrolysis process.

16. The method according to claim 4, when a mixture of lithium chloride and lithium carbonate salts is used as the lithium salt containing material, an initial mixture of lithium chloride and lithium carbonate salts is brought into contact with a hydrochloric acid solution and a flow of the anolyte withdrawn from the circulating anolyte stream undergoing depletion in LiCl during electrolysis, to produce a lithium chloride solution of a predetermined concentration; the lithium chloride solution of the predetermined concentration, after purification from impurities, is used as a replenishing solution for the circulating anolyte stream in the membrane electrolysis process.

17. The method according to claim 4, wherein when a mixture of lithium sulfate and lithium chloride salts is used as the lithium salt containing material, titanium coated with a noble metal selected from platinum, iridium, tantalum or ruthenium, is used as an anode in the membrane electrolysis process, and an anolyte stream is withdrawn from the circulating anolyte stream undergoing depletion in lithium sulfate and chloride and enrichment in H₂SO₄, which is brought into contact with a predetermined amount of CaO, Ca(OH)₂, or CaCO₃ until H₂SO₄ is completely neutralized producing a mixed solution of Li₂SO₄ and LiCl and a CaSO₄·2H₂O; the mixed solution of Li₂SO₄ and LiCl is separated from the CaSO₄·2H₂O precipitate, brought into contact with an initial mixture of Li₂SO₄ and LiCl salts to dissolve the initial mixture of Li₂SO₄ and LiCl and to obtain a mixed solution of Li₂SO₄ and LiCl with a predetermined concentration of lithium, which, after purification from impurities, is used as a replenishing solution for the circulating anolyte stream in the membrane electrolysis process; and cathodic hydrogen is utilized as fuel for generation of heating steam.

18. The method according to claim 17, wherein the volume of anolyte constantly withdrawn from the circulating anolyte stream undergoing depletion in Li₂SO₄ and LiCl after recycling is used as a replenishing mixed solution of Li₂SO₄ and LiCl for the circulating anolyte stream; anodic chlorine withdrawn from a gas separator of the gas separators is recycled into 36% hydrochloric acid or into NH₄Cl, sodium hypochlorite solution, or neutral calcium hypochlorite.

19. The method according to claim 4, wherein when a mixture of lithium sulfate, lithium chloride, and lithium carbonate salts is used as the lithium salt containing material, a volume of the anolyte is constantly withdrawn from the circulating anolyte stream undergoing depletion in Li₂SO₄ and LiCl and enrichment in H₂SO₄, which is first brought into contact with an initial mixture of Li₂SO₄, LiCl and Li₂CO₃ salts to produce a mixed solution of a predetermined lithium concentration; the mixed solution of predetermined lithium concentration is recycled into a mixed solution of Li₂SO₄ and LiCl which is used as a replenishing solution for the anolyte circulating stream in the membrane electrolysis process.
